(19) United States
(12) Patent Application Publication
(10) Pub. No.: US 2008/0277319 A1
(43) Pub. Date: Nov. 13, 2008

(54) FINE PARTICLE CARBON DIOXIDE TRANSFORMATION AND SEQUESTRATION

(76) Inventor: Michael D. Wyrsta, Santa Barbara, CA (US)

Correspondence Address: WESLEY B. AMES, 7031 LOS VIENTOS SERENOS, ESCONDIDO, CA, 92029, US

(21) Appl. No.: 11/749,741

(22) Filed: May 16, 2007

Related U.S. Application Data
(60) Provisional application No. 60/917,633, filed on May 11, 2007.

(51) Int. Cl. B03B 5/00; B03D 1/14

(52) U.S. Cl. 209/166; 209/155

(57) ABSTRACT

An energy efficient method and system for producing micron-sized particles and transforming and sequestering carbon dioxide into mineral carbonates is described, along with uses for the mineral carbonates produced in the process.

### RELATED APPLICATIONS

This application claims the benefit of Wyrsta, U.S. Provisional Appl. 60/917,633, which is incorporated herein by reference in its entirety, including drawings.

### FIELD OF THE INVENTION

The present invention relates to equipment and methods for sequestration and transformation of carbon dioxide generated by anthropogenic sources such as coal-fired power plants, industrial factories, and biofuel production plants.

### BACKGROUND OF THE INVENTION

The following discussion is provided solely to assist the understanding of the reader, and does not constitute an admission that any of the information discussed or references cited constitute prior art to the present invention.

CO₂ is a greenhouse gas that contributes to global warming. In 2005 there were 25 billion metric tons of anthropogenic CO₂ released into the atmosphere, approximately one third of that was from the combustion of coal for the production of electricity. Therefore, coal-fired power plants represent a logical place to begin CO₂ emission reduction strategies, as they contribute significant point source emissions. Some strategies include but are not limited to underground storage in geological formations or oil and gas depleted sites, biological fixation of CO₂ to plant material, and chemical conversion to water-soluble or water-insoluble mineral carbonates. Strategies of burying CO₂ are commonly referred to as carbon dioxide sequestration. However, conversion of CO₂ into mineral carbonates that can be used for industrial applications, such as building materials, can be referred to as carbon dioxide transformation since the carbon dioxide is reused for other anthropogenic purposes.

Of particular interest in this filing are CO₂ transformation and sequestration methods and technologies that rely on the use of solid particulates often originating from mineral mines. US APP 2004/0126293 A1, EP 1379469 B1, WO 02/085788 A1 and WO 2004/037 (each of which is incorporated herein by reference in its entirety) describe a process for CO₂ sequestration using water insoluble alkaline earth silicates to form insoluble metal carbonates. Most of these aqueous mineral carbonation processes claim the use of metal silicate in particulate form. The most preferable silicates are those that contain large amounts of magnesium and or calcium. Other metals that are suitable for aqueous mineral carbonation are also claimed.

The mineral aqueous mineral carbonation step involves the leaching of magnesium, calcium or another suitable metal or combination of metals and the subsequent reaction with dissolved hydrogen carbonate. The following is an exemplary reaction:

Mg₂SiO₄+2CO₂+2H₂O→2MgCO₃+SiO₂+2H₂O

US APP 2005/0180910 A1 describes a process for sequestration of CO₂ using chemical leaching of metal silicates followed by carbonate formation.

In U.S. Pat. No. 6,890,497 a process is described that sequesters CO₂ as a soluble solution of bicarbonates that are then disposed of in large bodies of water. This process also relies on the use of mineral materials, in this case, in the form of alkaline and alkaline earth metal carbonates.

All of these processes and any others that depend on mineral resources as a source of reactant or catalyst to sequester CO₂ must first obtain the mineral agents in a form that is acceptable for the reaction process.

O'Connor et al in a NETL workshop on aqueous mineral carbonation, given Aug. 8, 2001 describe a process for the use of easily mined silicate minerals such as olivine for CO₂ sequestration via mineral carbonates. In this presentation they state the need for approximately 11-12 kWh/ton of mineral material to be processed down to an average particle size of 75 μm. They also claim a 1 GW coal-fired power plant would require 30-40 kilotons/day of ground mineral, representing approximately 330 MW/day.

### SUMMARY OF THE INVENTION

The present invention concerns a method for efficiently obtaining mineral particles of sizes appropriate for carbon dioxide transformation and sequestration via mineral carbonation. Using this method, the invention further provides related methods for carrying out the carbon dioxide transformation, systems for performing the operations, and methods and corresponding materials for disposing of the mineral carbonates resulting from the process.

Thus, a first aspect of the invention provides a method for producing micron- or sub-micron-sized mineral particles from mineral and mining slimes or tailings to be used in a carbon dioxide sequestration reaction system, which involves classifying particles from silicate mineral mining slime or tailings such that mineral particles of a size suitable for use in such a carbon dioxide sequestration reaction system are obtained. In general, the classifying includes separating particles of a desired size from the slimes or tailings.

In certain embodiments, the method also involves reducing the size of particles from the slimes or tailings which are above a desired size to produce particles of the desired size, e.g., by grinding or milling, such as in a wet tower mill; the particles have an average equivalent spherical diameter of 1000 μm-500 μm, 500 μm-250 μm, 250 μm-100 μm, 100 μm-10 μm, 10 μm-1 μm, 1000 μm −500 μm, 500 μm-250 μm, 250 μm-100 μm, 100 μm-10 μm, 10 μm-1 μm, 100 μm-1 μm, or 50 μm-500 μm.

In particular embodiments, the slimes or tailings substantially comprise minerals selected from the group consisting of talc, olivine, serpentines, limestone, calcite, actinolite, amosite, brucite, magnesite, dolomite, forsterite, monticellite, wollastonite, diopside, enstatite, lizardite, potassium and sodium feldspars, antigorite and chrysotile; the slimes or tailings contain minerals containing elements from group IIa or Ia or both in the periodic table of the elements; the slimes or tailings contain minerals that contain metals suitable for carbon dioxide transformation and sequestration; the slimes or tailings contain at least 30, 40, 50, 60, 70, 80, or 90% of a mineral silicate, e.g., a mineral as previously indicated in this paragraph or otherwise identified herein as suitable for the present invention.

In particular embodiments, the method involves locating appropriate mineral tailings or slimes deposit, preparing those tailings and slimes for classification (e.g., in a manner suitable for the apparatus being used for the classification), classifying minerals based on desired particle size, milling particles from the mineral tailings and slimes to reduce the sizes of particles greater than the desired particle size; and preparing a slurry of particles of the desired particle size from fine milled and classified tailings and slimes.

A related aspect of the invention concerns a method for sequestering carbon dioxide produced by a carbon dioxide source, essentially by utilizing the mineral particles as produced by the first aspect. Thus, the method involves obtaining particles of a desired size obtained from mining slimes or tailings of a silicate mineral (e.g., by classifying silicate minerals from mining tailings or slimes to obtain particles of a desired size, combining mineral particles from that classifying with water to form a slurry, and reacting metals from those particles in the slurry with carbon dioxide containing emissions from the carbon dioxide source to form mineral carbonates. In most cases, the reacting is performed in a carbonate reactor.

In certain embodiments, the reacting is performed at elevated pressure and/or elevated temperature; the reaction is carried out at a pressure of at least 1, 5, 10, 20, 30, 40, 10-20, 20-30, 30-40, or 40-50 atm; the reacting is carried out at and a temperature of at least 100, 120, 130, 140, 150, 160, 100-120, 120-140, 130-150, 140-160, 150-170, or 170-200 degrees C. the reaction is carried out at a pressure of at least 10 atm and a temperature of at least 120 degrees C.; the reaction is carried out at a pressure of at least 20 atm and a temperature of at least 130 degrees C.; the reaction is carried out at a pressure of at least 30 atm and a temperature of at least 140 degrees C.; the reaction is carried out at a pressure of at least 40 atm and a temperature of at least 150 degrees C.; the reaction is carried out at a pressure of 30-50 atm and a temperature of 130-170 degrees C.; the reaction is performed at a pressure of about 40 atm and a temperature of about 155 degrees C.

In further embodiments, the method also involves leaching metals from the mineral particles (e.g., where the metals react to form mineral carbonates, thereby transforming and sequestering the carbon dioxide); the metals are leached by acid solution; the metals are leached by basic solution; the metals are leached by carbonic acid formed by dissolving carbon dioxide in water.

In still further embodiments the method also includes separating the mineral carbonates from unreacted components in the slurry; the method includes recycling the unreacted components into the slurry for additional reacting; the method includes solidifying the mineral carbonates; the method includes preparing the mineral carbonates as a powder or as particles with an average equivalent diameter of 200 μm-2 mm or 1 mm to 5 mm; the method also includes providing for use and/or using the mineral carbonates as filler in a building material, e.g., in drywall or drywall mud, cement, concrete structures such as extruded concrete structures such as blocks.

Also in particular embodiments, the carbon dioxide source is a fossil fuel burning power plant (e.g., coal, natural gas, coal gasification, and the like); the carbon dioxide source is an ethanol plant, a paper mill, or an oil sands production facility.

The configuration of the particular production system, the carbon dioxide source, and the provisions for providing the mineral particles and the carbon dioxide or derivative) in a location for reaction can be varied to meet the particular needs. Thus, in certain embodiments, the slurry is transported to the carbon dioxide source before said reacting (e.g., by pipeline); the carbon dioxide from the carbon dioxide source is transported to a site where the particles of a desired size are produced before the reacting (e.g., by pipeline) or by mobile container; the particles of a desired size are produced at the carbon dioxide source.

In particular embodiments, the method for producing the particles for reaction and/or the resulting particles are as described for the first aspect above.

Another related aspect concerns a method for producing mineral carbonates by obtaining silicate mineral particles of a desired size classified from mining tailings or slimes, combining the silicate mineral particles with water to form a slurry, and reacting the particles in the slurry with carbon dioxide (e.g., from a carbon dioxide source) to form the mineral carbonates. The carbon dioxide may, for example, be in the form of carbonic acid formed by dissolving the carbon dioxide in water. The method can also include separating the mineral carbonates from unreacted components of the slurry.

In certain embodiments, the method includes the classifying and/or size reduction of the particles (e.g., as described above); the particles are as described above; the reacting is carried out as described above; the mineral carbonates formed are used or otherwise disposed of, e.g., as described above.

Likewise, another aspect of the invention concerns a method for producing building materials by using mineral carbonates produced according to the present invention. Thus, in embodiments of this aspect, the method involves obtaining mineral carbonate materials produced by a method described above, and incorporating the mineral carbonate material in the building material (e.g., as filler).

In certain embodiments, the building material is or includes concrete; the building material is drywall.

In related aspects, the invention also concerns using the mineral carbonates in other ways, e.g., in cosmetics or as soil amendment.

Similarly, another aspect concerns a building material that includes mineral carbonates produced according to the present invention, e.g., contains at least 5, 10, 15, 20, 25, or 30% by weight of mineral carbonates formed by reaction of carbon dioxide from a carbon dioxide generating facility with metals leached from size classified silicate minerals obtained from mining slimes or tailings.

In particular embodiments, the mineral carbonates are produced by a method as described above; the particles are as described for an aspect above.

A still further aspect provides a system for producing classified mineral particles from mining fines, where the system includes a separator(s) (e.g., a hydrocyclone) suitable for separating particles of a desired size between 1000 and 1 nm (or other size as indicated above), and a mill capable of reducing particles to the desired size.

The system can also include other useful components, e.g., pressure pumps, mixers, and the like.

Additional embodiments will be apparent from the Detailed Description and from the claims.

### BRIEF DESCRIPTION OF THE DRAWINGS

FIG. 1 schematically illustrates a generalized operation to produce fine particles from run of mine mineral materials.

FIG. 2 schematically shows a generalized process for classifying particulate silicate minerals beginning with mining slimes and the like.

### DETAILED DESCRIPTION OF THE PREFERRED EMBODIMENTS

The method of this invention provides an efficient and cost effective method for using silicate minerals for CO₂ sequestration, forming mineral carbonates. It also concerns the use of other disposal of the resulting mineral carbonates, such as in building materials.

As described in the Background, O'Connor et al in a NETL workshop on aqueous mineral carbonation, given Aug. 8, 2001 describe the use of easily mined silicate minerals for CO₂ sequestration via mineral carbonates. A difficulty associated with the described method is the high energy cost of approximately 11-12 kWh/ton needed to process the mineral material down to an average particle size of 75 μm. Based on the estimates they provided, a 1 GW coal-fired power plant would require 30-40 kilotons/day of ground mineral, representing approximately 330 MW/day in energy consumption just for processing the mineral material associated with CO₂ sequestration.

The high cost associated with fine grinding of mineral particles for mineral carbonation processes poses a challenge to mineral carbonation systems: being a scalable carbon dioxide sequestration solution at reasonable energy costs. According to the Dept. of Energy and NETL Carbon Sequestration Technology Roadmap and Program Plan 2006, the goal is to obtain a CO₂ sequestration system or systems that offer 90% CO₂ capture with 99% storage permanence at less than 10% increase in energy cost.

The current invention describes a general method for obtaining and processing minerals at substantially lower cost than processing run of mine ore. While mineral carbonation is known to produce very stable and useful carbonate byproducts, the cost of grinding the minerals has been prohibitive for CO₂ sequestration and transformation applications. By applying the current invention to prepare minerals, mineral carbonation can be a viable solution in meeting DOE objectives for CO₂ sequestration and transformation systems.

### Mineral Slimes

There is a clear need for the production of fine mineral particles that are suitable for mineral carbonation reactions and that cost significantly less than current state of the art mining, crushing, grinding and milling. This can be accomplished in accordance with the present invention by further processing pre-processed mining slimes and tailings that are previously generated by other mining operations. The use of such slimes and the fine portions of tailings thus avoids the extremely high energy costs that would otherwise be required to mine and crush and grind the mineral to useable size. In this way, the present method provides cost effective methods and materials for carbon dioxide sequestration.

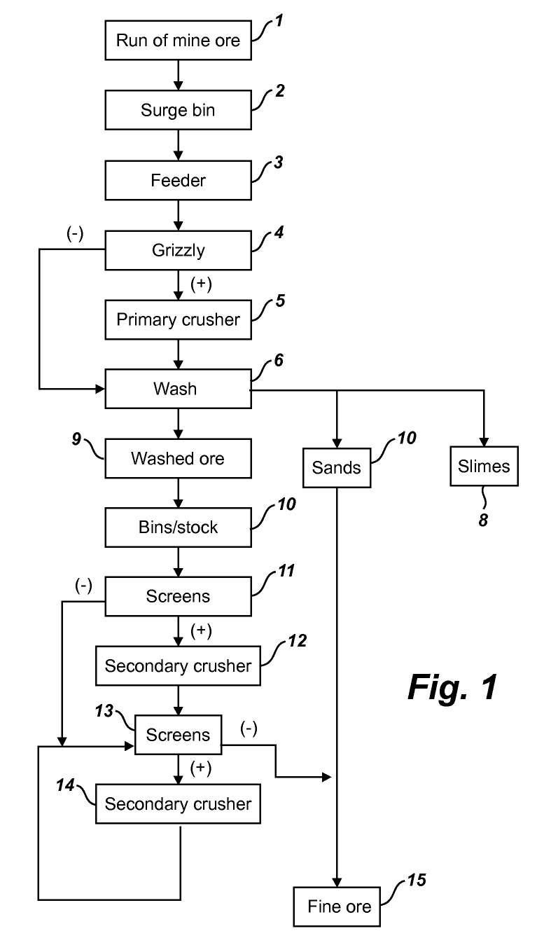

To assist in understanding the present invention, FIG. 1 is a schematic of diagram of typical mineral processing configured to produce fine ores, a process which would consume a great deal of energy. The production of mineral fines would start with mining of large pieces of minerals (run of mine ore) 1 up to 2 meters in diameter that are passed into a surge bin 2 and then on to a grizzly 4 and then crushed in a primary crusher 5. Fines and undersized material from the grizzly 4 are washed along with the output of 5 generating washed ore 9, sands 7, and slimes 8. Slimes can potentially be generated (and usually are) as part of the output at any crushing, grinding or screening process along the way. Slimes are recognized in mining as ultra-fine materials that may cause processing problems if left in the process. The washed ore 9 is then sent to bins 10 and then on to screens 11. Undersized material from screen 11 is directly to a feed that supplies another set of screens 13. Oversized material from 11 moves to a secondary crusher 12 and then on to finer screens 13. Oversized material from 13 moves to a tertiary crusher or grinder 14 until the undersize material is produced and screened into the final ore 15. This entire process starting at 1 consumes an enormous amount of energy and in the case of generating 75 μm particles suitable for mineral carbonation reactions would cost approximately 11-12 kWh/ton of mineral produced or approximately 30% of the energy produced by a 1 GW coal-fired power plant.

While FIG. 1 is a schematic of a general flow sheet describing conventional mineral processing, as indicated above, it also represents a typical flow sheet for generating a source of fines for use in CO₂ sequestration. Specific details of operation, equipment set-up and implementation are dependent on each mineral to be produced, site of mine, quantity and quality of fine ore produced. This process is energy intensive and therefore cost prohibitive.

In contrast to the energy required for the above production, the process described for this invention can be used to obtain and produce very fine mineral particles (sub 50 μm) for use in mineral carbonation reactions at substantially reduced energy costs as compared to traditional mining and milling (e.g., as illustrated in FIG. 1). This process may be applied to processing minerals for a variety of applications, such as for power plant CO₂ emission reduction strategies, (e.g., coal-fired power plant CO₂ emission reduction strategies), chemical plant operations aiming to reduce CO₂ output, petroleum refineries that generate CO₂ during coke burn-off on catalyst regeneration, ethanol production plants, flaring of natural gas, syn gas/Fischer Tropsch production facilities, and producers of building materials such as concrete and drywall.

In connection with producing materials in the present invention, particle size can be measured in a variety of ways and often sizes are reported as an average of equivalent spherical diameter. Test sieving is reliable for particles between 100,000 μm-10 μm, elutriation (a method of particle sizing using an upward current of fluid, usually water or air) is reliable in the range of about 40 μm-5 μm, optical microscopy 50 μm-0.25 μm, gravity sedimentation 40 μm-1 μm, centrifugal sedimentation 5 μm-0.05 μm, and electron microscopy 1 μm-0.005 μm.

Production of Mineral Particles from Mining Slimes for CO₂ Sequestration

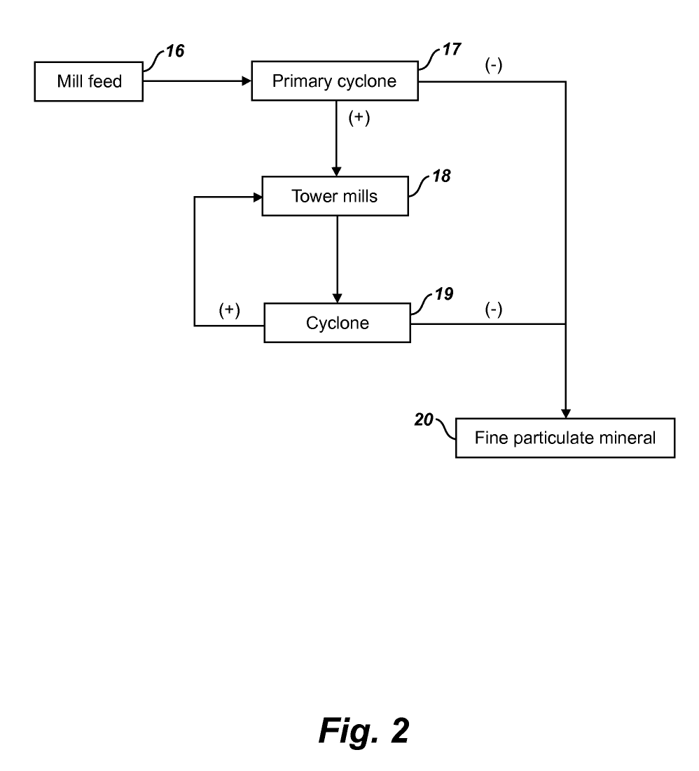

In the current invention, the first stage of which is shown schematically in FIG. 2, costs and energy usage are kept relatively low by using slimes (and other fine particles) created in preexisting and ongoing mining operations (e.g., in the process shown in FIG. 1) as the feed material for the production of fine mineral ore for CO₂ sequestration reactions. Slimes created during normal mining and milling operations are ultra-fine minerals that are typically discarded at the mining site. Slimes are composed of the same mineral content as the parent mineral under mining operations. They are often sub 50 μm and will sometimes be substantially smaller, e.g. as small as 200 nm in average diameter. These materials represent an ideal starting place for the production of CO₂ transformation and sequestration mineral particles. Through the cyclone and mill system described as a preferred embodiment in the current invention, these slimes are processed with minimal energy cost into fine mineral particulates to maximize the available surface area for reacting with CO₂ in chemical reactions.

In some cases direct use of the particles in suitable conditions may be all that is needed for CO₂ sequestration systems. For example, US APP 2004/0126293 A1 (which is incorporated herein by reference in its entirety) describes a process that calls for a silicate rich in magnesium or calcium with an average diameter of 500 μm and more preferably 200 μm. Average diameter is defined as volume medium diameter D(v,0.5), meaning that 50 volume % of the particles have an equivalent spherical diameter that is smaller than the average diameter and 50 volume % of the particles have an equivalent spherical diameter that is greater than the average diameter. In the present invention it may satisfactory for the process described in US APP 2004/0126293 A1 to use the tailings or slimes from an olivine or talc mining operation without further size reduction, and in some cases, without further size separation.

However, it is highly desirable and more effective in carbonation reactions to have mineral particles that are 50 μm or smaller. FIG. 2, is a representative flow diagram of the current invention to process slimes into CO₂ transformation and sequestration reactants with specific details of operation, equipment set-up and implementation being dependent on each mineral to be produced, site of mine, quantity and quality of fine ore produced. A person skilled in processing of the respective minerals can select such details to provide an effective system (e.g., based on knowledge of processing along with process testing as needed).

There are a number of mineral slimes and tailings that are well suited for CO₂ transformation and sequestration reactions. Examples include talc, olivine, serpentines, limestone, calcite, actinolite, amosite, brucite, magnesite, dolomite, forsterite, monticellite, wollastonite, diopside, enstatite, lizardite, potassium and sodium feldspars, antigorite and chrysotile.

Before processing the tailings and slimes of a mining site, those skilled in the art should first determine the mineral content and composition of the tailings/slimes. If the tailings/slimes are acceptable for CO₂ transformation and sequestration reactions, yet need classification or size reduction, then they can be processed as illustrated in FIG. 2. The tailings/slimes are prepared by those skilled in the art for the mill feed 16. Once the mineral tailings and slimes have passed into the primary cyclone 17 they begin their first classification cycle. Small particles that are under the separation size rated for the cyclone(s) 17 move onto the final particulate mineral stage 20. The products in 20 may be a stored on site or moved directly into the carbonation reactor. The oversized material classified in 17 is then sent to a tower mill or similar device 18 that grinds the tailings/slimes further, representing the size reduction step. A process loop is formed between the tower mill 18 and another cyclone(s) 19. Over sized material received from 18 is sent back to 18 after separating undersized material in 19. The undersized material from 19 is sent to the fine particulate mineral 20. Depending on which CO₂ transformation or sequestration process that is to be used, special preparations may be needed to further process or prepare the mineral fines for reacting with CO₂. Such special preparations will be apparent to persons familiar with the particular transformation or sequestration process.

While many different sizes of particles may be obtained, preferably the average size of the particles will be no larger that 1000 μm (i.e., 1 mm), but preferably the particles are much smaller, even sub-micron. For example, useful ranges for the average particle size include an average equivalent spherical diameter of 1000 μm-500 μm, 500 μm-250 μm, 250 μm-100 μm, 100 μm-10 μm, 10 μm-1 μm, 1000 nm-500 nm, 500 nm-250 nm, 250 nm-100, 100 nm-10 nm, and 10 nm-1 nm. Of these ranges, the ranges of 100 μm-10 μm, 10 μm—1 μm, 1000 nm-500 nm, 500 nm-250 nm, 250 nm-100 are particular advantageous because they offer a beneficial balance of reaction rate without excessive processing cost.

### Definitions Relating to Mineral Mining and Processing

Alkaline earth metals: Any metal from group IIA in the periodic table of the elements. They are beryllium (Be), magnesium (Mg), calcium (Ca), strontium (Sr), barium (Ba) and radium (Ra).

Alkaline metals: Any metal from group IA in the periodic table of the elements. They are lithium (Li), sodium (Na), potassium (K), rubidium (Rb), cesium (Cs) and francium (Fr).

Classification: Separation of minerals based on size and density

Crushing: Reducing the size of minerals down to mm length scales by mechanical means

Grinding: Reducing the size of minerals down to micron length scales by mechanical means

Grizzly: A rough screen to remove undersize material and fines that may damage or hinder the primary crusher.

Mineral Carbonate or metal carbonates: Any water soluble or water insoluble compound of the following formula MₓH_{y}(CO₃), where M is Mg, Ca, Sr, or Ba and x=1, z=1, y=0; Or x=1, y=2, z=2; Or where M is Li, Na, K, Rb, or Cs and x=2, y=0, z=1; Or x=1, y=1, z=1. Alternatively a carbonate can be any metal bound to CO₃²⁻ groups such as iron carbonate (FeCO₃), nickel carbonate (NiCO₃), and lanthanum carbonate La₂(CO₃)₃.

Primary crushing: Reduction of large rock raw materials from up to 2 m in average equivalent diameter to a size suitable for secondary crushing

Run of mine ore: The large rocks and material taken out the ground; average grade, size or quality

Secondary crushing: Further reduction of mineral size for preparation of fine grinding

Slimes: Defined here as the ultra-fine material discarded on site of mineral processing plants and mines

Reaction of Particulate Minerals with Carbon Dioxide to Form Mineral Carbonates

The reaction of the silicate mineral slimes with carbon dioxide to form mineral carbonates has been described. The reaction generally involves leaching of suitable metals from silicate minerals. Such leaching usually involves acidic or basic leaching, e.g., by carbonic acid formed by dissolving carbon dioxide in water. The metals react with the dissolved CO₂ (e.g., in the form of carbonic acid and other carbonates) to form a mineral carbonate. Such leaching and reacting can be performed as separate steps, or alternatively can be performed in a single step.

The process of reacting CO₂ with a mineral to form insoluble mineral carbonates begins with the collection of suitable mineral fines. As described above, these can be from the corresponding tailing ponds or other source of mining slimes or tailings. The mineral fines may in some cases be used directly or following classification to separate and select particles of a desired size grade. In many cases, however, the process will include further size reduction for at least a portion of the materials from the mineral fines. For example, particles above the desired size can be reduced in size, e.g., wet ground in a tower mill, and classified, e.g., in hydrocyclones, to give an appropriately sized slurry of particles.

In practice the slurry fed to a carbonation reactor will usually contain approximately 40% solids. The slurry fed to the carbonation reactor will often be a combination of first pass slurry, along with recycled slurry from which mineral carbonate product has been separated. For such recycling, the mineral carbonate products are separated, and the remaining slurry is moved to a slurry make-up and surge pool where make-up water as added. The unreacted slurry can then be added back to the original slurry feed.

In many systems, the slurry is pumped at high pressure into a carbonation reactor. The carbonation reactor can advantageously be at elevated pressure and temperature, e.g., a pressure of about 40 atm and a temperature of approximately 155° C. The reactor is normally designed and optimized for each particular mineral type and CO₂ emission source. Highly preferably the carbonation reactor is configured as a continuous-flow reactor. Reacted slurry, that contains mineral carbonate precipitate, unreacted minerals, water and CO₂ leaves the carbonation reactor and is decompressed. Reactants and products are separated and recycled or disposed of, respectively.

A suitable reactor can be of a number of different types as known to chemical engineers. For example, a suitable reactor can be a continuous stirred tank reactor (CSTR), a loop reactor, or a plug flow reactor (PFR).

### Uses or Disposal of Mineral Carbonate Materials Generated During Carbon Dioxide Transformation and Sequestration

Following reaction in the carbonation reactor and separation of the product mineral carbonates, those product mineral carbonates are used or disposed of in some manner. One of the advantages of the mineral carbonate transformation and sequestration method involves the stability of sequestration, as well as the relatively simple disposal of the materials generated in the process. Another advantage of the present invention is that little or no monitoring is needed of the mineral carbonate for CO₂ leakage.

If desired, the mineral carbonates can be safely and effectively disposed of in a variety of different ways without significant environmental issues. For example, the mineral carbonates can be solidified and disposed of in a similar manner to waste rock, e.g., by transporting and disposing in the ocean or as fill on land. For example, if the mineral carbonates are solidified in large units, they may be used for artificial reef building or may simply be dropped into deeper water. For disposal as fill on land, the mineral carbonates would, in many cases, be disposed of at or near the site where they are generated, but may also be used as fill at any of a variety of construction sites and the like.

Alternatively, various mineral carbonates, but especially calcium carbonates, are very commonly used for a variety of different applications, including, for example as fillers in various construction materials, as soil amenders, in cosmetics, and the like. The mineral carbonates produced in the carbon dioxide sequestration process can be used in such applications, which are thus part of the present invention. For example, the mineral carbonates, e.g., calcium and/or magnesium carbonates, can be used as fillers in drywall board, in cement, in road materials, and in cosmetics.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the particular mineral slime utilized, the carbon dioxide source, and the disposition of the resulting mineral carbonate materials. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

1. A method for producing micron- or sub-micron-sized mineral particles from mineral and mining shines or tailings to be used in a carbon dioxide sequestration reaction system, comprising
classifying particles from silicate mineral mining slime or tailings thereby providing mineral particles of a size suitable for use in said carbon dioxide sequestration reaction system.

2-21. (canceled)

22. A method for sequestering carbon dioxide produced by a carbon dioxide source, comprising
classifying silicate minerals from mining tailings or shines to obtain particles of a desired size;
combining mineral particles from said classifying with water to form a slurry; and
reacting metals from said particles in said slurry with carbon dioxide containing emissions from said carbon dioxide source to form mineral carbonates.

23. The method of claim 22, wherein said reacting is performed in a carbonate reactor.

24. The method of claim 23, wherein said reacting is performed at a pressure of at least 10 atm and a temperature of at least 100 degrees C.

25. (canceled)

26. The method of claim 23, wherein said reacting is performed at a pressure of at least 40 atm.

27. The method of claim 23, wherein said reacting is performed at a pressure of at least 30 atm and a temperature of at least 150 degrees C.

28. The method of claim 23, wherein said reacting is performed at a pressure of about 40 atm and a temperature of about 155 degrees C.

29. The method of claim 22, further comprising leaching metals from said mineral particles, wherein said metals react to form mineral carbonates, thereby sequestering said carbon dioxide.

30. The method of claim 22, further comprising separating said mineral carbonates from unreacted components in said slurry.

31. The method of claim 30, further comprising recycling said unreacted components into said slurry for additional reacting.

32. The method of claim 22, further comprising solidifying said mineral carbonates.

33. The method of claim 22, further comprising preparing said mineral carbonates as a powder.

34. (canceled)

35. The method of claim 22, further comprising using said mineral carbonates as filler in a building material.

36. The method of claim 35, wherein said building material is a drywall board.

37. The method of claim 35, wherein said building material is a cement.

38. The method of claim 35, wherein said building material is an extruded concrete structure.

39. The method of claim 22, wherein said carbon dioxide source is a fossil fuel burning power plant.

40. The method of claim 22, wherein said carbon dioxide source is an ethanol plant.

41. The method of claim 22, wherein said carbon dioxide source is a paper mill.

42. The method of claim 22, wherein said carbon dioxide source is an oil sands production facility.

43. The method of claim 22, wherein said slurry is transported to said carbon dioxide source before said reacting.

44. (canceled)

45. The method of claim 22, wherein carbon dioxide from said carbon dioxide source is transported to a site where said particles of a desired size are produced before said reacting.

46. The method of claim 45, wherein said carbon dioxide is transported by pipeline.

47. (canceled)

48. The method of claim 22, wherein said particles of a desired size are produced at said carbon dioxide source.

49. A method for sequestering carbon dioxide produced by a carbon dioxide source, comprising
obtaining silicate mineral particles of a desired size classified from mining tailings or shines;
combining said silicate mineral particles with water to form a slurry; and
reacting said particles in said slurry with carbon dioxide containing emissions from said carbon dioxide source to form mineral carbonates.

50-85. (canceled)
